(19) United States
(12) Patent Application Publication
(10) Pub. No.: US 2024/0386628 A1
(43) Pub. Date: Nov. 21, 2024

(54) CLOUD-CONNECTED X-RAY COMPUTED TOMOGRAPHY

(71) Applicant: Lumafield, Inc., Cambridge, MA (US)

(72) Inventors: Eric Morgan Van Albert, Somerville, MA (US); Parker Harvey Porfilio, Somerville, MA (US); Sebastian Gerd Ahling, Medford, MA (US); Brett Michael Warne, San Francisco, CA (US)

(21) Appl. No.: 18/633,665

(22) Filed: Apr. 12, 2024

Related U.S. Application Data
(60) Provisional application No. 63/467,452, filed on May 18, 2023.

(51) Int. Cl. G06T 11/00; G06T 3/4092

(52) U.S. Cl. CPC G06T 11/008; G06T 3/4092; G06T 2210/08

(57) ABSTRACT

Provided herein are methods, apparatuses, computer program products, and systems for cloud-connected X-Ray computed tomography. One method can include receiving radiograph data that has been at least partially processed locally at a computer coupled with a computed tomography scanner; generating a three-dimensional reconstruction from the radiograph data; breaking the three-dimensional reconstruction into chunks of data selected to match an expected access pattern for data in the three-dimensional reconstruction; compressing the chunks of data to form compressed chunks; storing the compressed chunks on one or more computers communicatively coupled with the computed tomography scanner; producing, on the one or more computers, a compressed and downsampled subset of the three-dimensional reconstruction from a proper subset of the compressed chunks in response to a request to access the three-dimensional reconstruction in a specified view; and sending the compressed and downsampled subset of the three-dimensional reconstruction of the physical object to a target computer.

### CLAIM OF PRIORITY

This patent application claims priority to and the benefit of U.S. Provisional Patent Application Ser. No. 63/467,452, filed on May 18, 2023.

### BACKGROUND

This specification relates to X-Ray computed tomography (CT).

X-Ray computed tomography (CT) is a technique which can be used by manufacturers in order to determine the quality of the products which they produce. X-Ray CT is particularly useful to give manufacturers the ability to inspect certain parts of their products in a non-invasive, non-destructive fashion. Given this, X-ray CT is becoming more popular in production manufacturing settings where quality control is of high importance.

X-Ray CT requires multiple computational steps in order to produce an output that delivers value to the end customer. These computational steps include but are not limited to storing the two-dimensional (2D) radiographs, generating a three-dimensional (3D) reconstruction from the 2D radiographs, storing the 3D reconstruction, and analyzing the 3D reconstruction so as to make decisions about the quality of their product.

### SUMMARY

This specification describes technologies relating to cloud-connected X-Ray computed tomography in which data is processed and visualized in two or more connected locations. In particular, this specification describes systems and techniques relating to distributing the computational steps required for using a CT scanner across computers both co-located with the CT scanner and in remote locations such as the cloud.

Particular embodiments of the subject matter described in this specification can be implemented to realize one or more of the following advantages. The systems and methods described can provide a hybrid (e.g., edge plus cloud) X-Ray computed tomography system. The hybrid X-Ray computed tomography system can allow for processing and/or network conditions at a local computer coupled with a computed tomography scanner, such that processing time and/or communication latency can be improved. Radiographs and reconstructions can be compressed before uploading to remote computer system(s) from the local computer. Thus, less network bandwidth is used. If reconstruction is performed at the remote computer system(s), the latency from radiographs available to generate a reconstruction can be lowered. The remote computer system(s) can use less storage space because compressed radiographs are uploaded.

The processing at the remote computer system(s) can be faster and more computationally efficient at a lower economic cost through the data storage techniques at the remote computer system(s). The X-Ray CT data (e.g., radiographs and/or reconstructions) can be stored in a chunked format. The system can read the necessary chunks at the appropriate time for an operation that uses and/or processes the X-Ray CT data. This can minimize total data transfer and can lower the latency between storage and the remote computer system(s) doing the algorithmic processing. The reconstruction data can be compressed on a per-chunk basis. Thus, the system does not need to load and decompress the entire reconstruction in order to work on a specified portion of the reconstruction, and the system can just load and individually decompress the appropriate chunks as needed.

The system can stream data from the remote computer(s) (e.g., the cloud) to a target computer (e.g., a low-end machine running a browser) efficiently. Full-resolution/native data can be downsampled to a size that can be transferred over the network (e.g., the Internet) efficiently and that the target computer (e.g., a graphics processing unit) can handle. In some implementations, a cloud worker can process the raw/native data and downsample the data to an appropriate size on-the-fly. In some implementations, the system can pre-generate downsampled caches using a technology such as MipMap. Although initial storage space is higher, the consistent latency can be lower because the downsampled data is not generated on-the-fly, potentially at a time when processing resources are in high demand.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an X-Ray computed tomography system.

FIG. 2 is a flowchart showing an example of operations to process X-Ray computed tomography data in two or more connected locations.

FIG. 3 is a flowchart showing an example of a process to compress and send radiograph data.

FIG. 4 is a flowchart showing an example of a process to stream X-Ray computed tomography data to a target computer.

FIG. 5 is a flowchart showing an example of a process to pre-generate dataview outputs using MipMap.

Like reference numbers and designations in the various drawings indicate like elements.

### DETAILED DESCRIPTION

A CT scanner (e.g., CT scanning device 130) can acquire a set of 2D images from an image detector (e.g., detector 136). These images represent the amount of X-ray energy that the image detector detects. The X-ray energy, which is emitted from an X-ray source (e.g., X-ray source 133), can contain distinct energies that are subsequently attenuated by any matter (e.g., scan target) between the X-ray source and the image detector. The difference in X-ray energy emitted by the X-ray source and the X-ray energy captured by the image detector provides information about the materials and densities of materials of the matter within the path of the X-ray photons.

The detector 136 can be configured to detect at least one x-ray signal and/or at least one fluorescence signal (i.e., visible light). In some implementations, detector 136 includes any suitable combination of a complementary metal-oxide-semiconductor (CMOS) digital camera sensor, a red-green-green-blue (RGGB) Bayer filter, an optical camera, a monochromatic optical camera, 1D line array detector, a back-side-illuminated sensor, a front-side-illuminated sensor, a charge-coupled device (CCD) detector, a photodiode, an X-ray flat panel detector, a linear array X-ray detector. In some implementations, detector 136 is configured to detect fluorescence signals. In various example implementations, detector 136 can be aimed directly at a scintillator.

The image acquired from the image detector can be referred to as a radiograph, which represents the raw data from the image detector and/or can include postprocessing techniques such as denoising, deblurring, etc. Henceforth, the term “2D radiograph” refers to either the direct data from the image detector, or the data that has undergone postprocessing techniques to improve the quality of the image.

A CT scan commonly utilizes a method where multiple 2D radiographs of a single item are acquired, where the primary difference between the system configuration for each 2D radiograph is the orientation or location of the scan target relative to the X-ray source and the image detector. In one example, the scan target can be placed between the X-ray source and the image detector on a mechanical turntable. The mechanical turntable can rotate in fixed steps that sum to a 360° revolution, and can stop after each step to acquire a radiograph, so that the resulting set of 2D radiographs include images from multiple vantage points around the object. In one example, the scan target can rotate exactly one degree between each 2D radiograph, thus making a full CT scan comprise 360 radiographs.

In some implementations, set forth herein is a process of X-ray CT scanning, wherein the methods produce a 3D image of a scanned target or targets. This 3D image is a reconstruction derived from a series of 2D X-ray radiographs. Unlike visible light or 2D X-ray radiography, a 3D reconstruction, which is a computer data structure that provides data representing the physical object in 3D space, can provide dimensionally accurate spatial and material information about both the inside and outside of scan target or targets, or a part or component thereof.

Before being input to the 3D reconstruction algorithm, the radiographs can be further processed in a number of ways. In some implementations, the radiographs can be summed (i.e., combined) and/or averaged before being reconstructed to produce a 3D reconstruction. In some implementations, the radiographs can be individually or collectively processed to improve resulting reconstruction data quality and to reduce artifacts of the X-ray CT process, such as beam hardening, ring artifacts, or other common artifacts. In some implementations, radiograph processing can also produce calibration information to improve resulting reconstruction data quality.

The X-ray CT scanner settings used to acquire a scan (herein “acquisition settings”) that produce the aforementioned radiographs, as well as associated metadata about the scan, can include various sources of data, and can be used in combination with a trained model for anomaly detection. In some example implementations, the trained model can be a trained machine learning model. For further details of such processes, see the systems and techniques described in U.S. Provisional Patent Application No. 63/417,469 filed on Oct. 19, 2022, and titled, “ARTIFICIAL INTELLIGENCE ANOMALY DETECTION USING X-RAY COMPUTED TOMOGRAPHY SCAN DATA”, which application is hereby incorporated by reference.

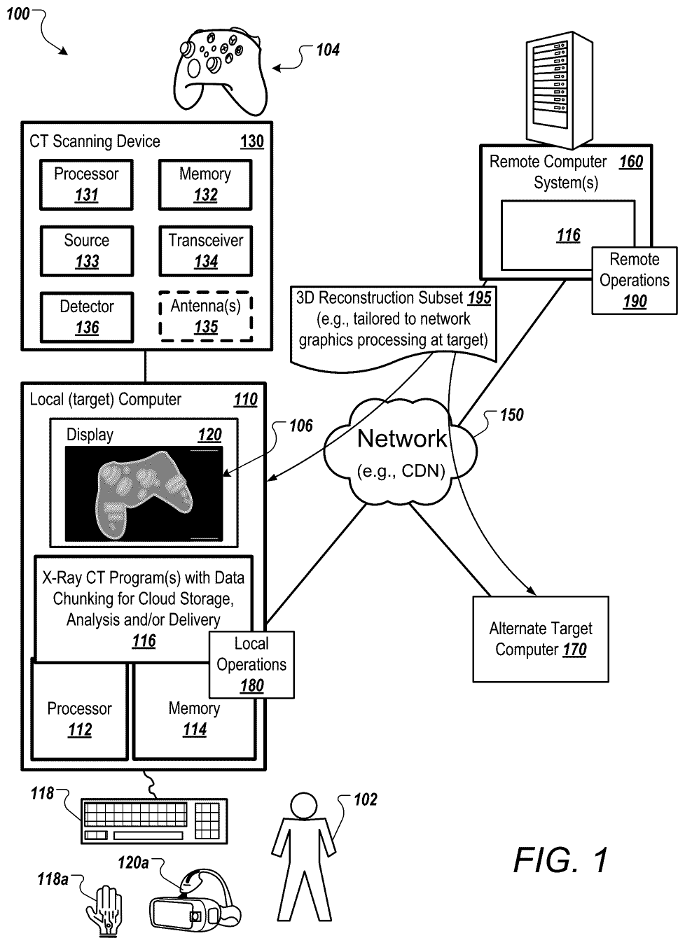

FIG. 1 shows an example of an X-Ray computed tomography system 100. A CT scanning device 130 can be configured to perform CT imaging of a physical object. For example, the CT scanning device 130 can be used to inspect a part or product that is being designed or manufactured. The CT scanning device 130 can obtain radiographs data for a physical object that has been scanned by the CT scanning device 130. In some implementations, an industrial CT scanner can acquire multiple (tens to thousands of) 2D X-Ray images (radiographs) as a part spins on a turntable through a 360 degree revolution between an X-ray source and an X-ray detector. For example, the CT scanning device 130 can scan an XBOX® controller 104.

CT scanning device 130 can include at least one processor 131. Processor(s) 131 can be embodied by any computational or data processing device, such as a central processing unit (CPU), application specific integrated circuit (ASIC), or comparable device. The processor(s) 131 can be implemented as a single controller, or a plurality of controllers or processors.

CT scanning device 130 can include at least one memory 132. The memory 132 can be fixed or removable. The memory 132 can include computer program instructions or computer code contained therein. Memory 132 can be any suitable storage device, such as a non-transitory computer-readable medium. The term “non-transitory,” as used herein, can correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory can be used. The memories can be combined on a single integrated circuit as the processor, or can be separate from the one or more processors. Furthermore, the computer program instructions stored in the memory, and which can be processed by the processors, can be any suitable form of computer program code, for example, a compiled or interpreted computer program written in any suitable programming language.

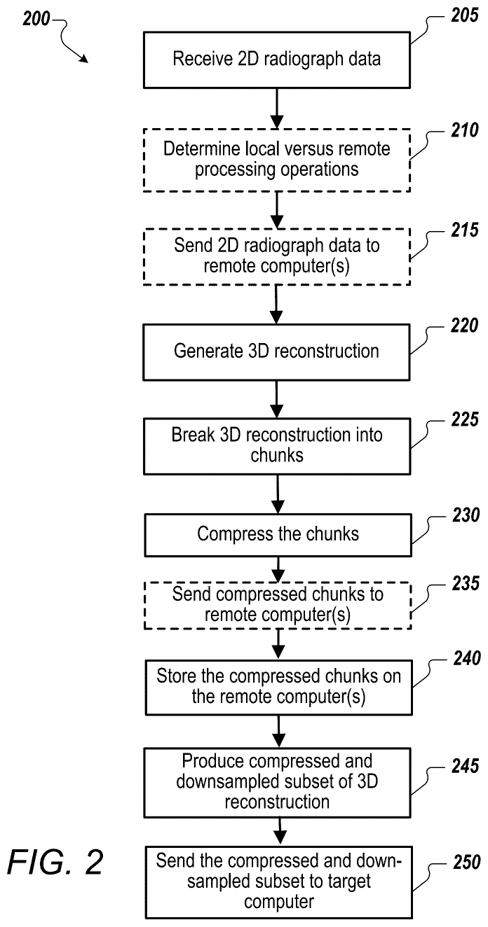

Processor 131, memory 132, and any subset thereof, can be configured to provide the algorithmic functionality corresponding to the various blocks of FIGS. 2-5 in addition to being configured to provide CT object scanning and data acquisition functionality. Although not shown, the devices can include positioning hardware, such as mechanical, opto-electric, or micro electrical mechanical system (MEMS) hardware, which can be used to move the physical object and/or internal components of the device 130. The CT scanning device 130 can also include locating hardware, such as a Global Positioning System (GPS) receiver, to determine a location of the device 130. Other sensors are also permitted, and can be configured to determine location, elevation, velocity, orientation, and so forth, such as barometers, compasses, and the like.

CT scanning device 130 can include at least one X-Ray source 133 configured to emit X-rays. In some implementations, X-ray source 133 can be at least one of a sealed tube-based X-ray source, an open tube-based X-ray source, a cold-cathode X-ray source, a rotating anode X-ray source, a stationary anode X-ray source, a liquid metal anode X-ray source, and triboluminescent X-ray source.

As shown in FIG. 1, transceiver 134 can be included, and in some implementations, at least one antenna 135 is also included. CT scanning device 130 can have many antennas, such as an array of antennas configured for multiple input multiple output (MIMO) communications and/or multi radio access technology (RAT) antenna(s). Other configurations of these devices, for example, can be provided. Transceiver 134 can be a single unit or device (configured both for transmission and reception) or a transmitter and a separate receiver. In some implementations, the antenna(s) 135 are optional, and direct connection (e.g., by Ethernet cable) can be used. In general, communicative coupling through a local wired and/or wireless network can be employed.

The memory and the computer program instructions can be configured, with the processor for the particular device, to cause a hardware apparatus to perform one or more of the processes described in connection with FIGS. 2-5. Therefore, in some implementations, a non-transitory computer-readable medium is encoded with computer instructions that, when executed in hardware, perform a process such as one of the processes described herein. In some cases, one or more of the processes described herein are implemented entirely in hardware. As noted above, in some implementations, these processes can be performed by the CT scanning device 130, and so no separate computer 110 is needed. In such implementations, the computer 110 and the CT scanning device 130 are integrated into a single device, rather than being in separate devices as shown in FIG. 1. In some implementations, the CT scanning device 130 is an inexpensive scanning device with minimal processing capabilities, and a separate computer 110 is communicatively coupled with the CT scanning device 130 and is configured to perform one or more of the processes described in connection with FIGS. 2-5.

In any case, the system 100 can generate a three-dimensional reconstruction of the physical object, e.g., XBOX® controller 104, from the radiograph data at a local computer 110 (e.g., on the edge) and/or remote computer system(s) 160 (e.g., in the cloud). The local computer 110 includes a processor 112 and a memory 114, and the computer 110 can be connected to a network 150, which can be a private network, a public network, a virtual private network, a wired or wireless network, etc. In some implementations, the network 150 can be a content delivery network (CDN), e.g., operating over the Internet. The CDN can include a system of pipes and caching servers to move large amounts of data around the globe and serve it with low latency to global users. The processor 112 can be one or more hardware processors, which can each include multiple processor cores. The memory 114 can include both volatile and non-volatile memory, such as RAM and Flash RAM. The computer 110 can include various types of computer storage media and devices, which can include the memory 114, to store instructions of programs that run on the processor 112.

The local computer 110 is co-located with the CT scanning device 130. The local computer 110 can be connected to the CT scanning device 130 via a local network which the manufacturer controls or via a local network which a user controls. The local computer 110 can be physically located within the same chassis as the CT scanning device 130. The co-located computer 110 can be physically located within a separate chassis from the CT scanning device 130.

In any case, the programs that run on processor 112 from memory 114 include one or more X-Ray CT programs with data chunking for cloud storage, analysis, and/or delivery, such as X-Ray CT program(s) 116. The program(s) 116 can run locally on computer 110, remotely on a computer of one or more remote computer systems 160 (e.g., one or more third party providers' one or more server systems accessible by the computer 110 via the network 150) or both locally and remotely. Operations, e.g., local operations 180 and/or remote operations 190 can be stored as instructions in the memory 114 (and/or in the one or more remote computer systems 160) and can be performed by the X-Ray CT program(s) 116. The remote computer systems 160 can be physically located within third-party cloud-computing data centers such as AWS, GCP, Azure, etc., or can be located within a manufacturer-controlled cloud computing data center.

The X-Ray CT program(s) 116 presents X-Ray CT data on a display device 120 of the computer 110. The X-Ray CT data can include 2D radiograph and/or 3D reconstruction renderings. In some implementations, the computer 110 can display a 3D reconstruction to a user. In some implementations, a user 102 can view the 3D reconstruction in a user interface of the display device 120 or a computer application in order to manually inspect details of the part or product. In some implementations, the computer(s) 110, 160 can be used to automatically generate decisions as to the quality of the part or product being produced and can display the decision on the display device 120.

For example, the CT scanning device 130 can scan an XBOX® controller 104 to generate 2D radiographs and the local computer 110 and/or the remote computer system(s) 160 can process the 2D radiographs to produce a 3D reconstruction, which can be delivered as a subset 195 of the 3D reconstruction, for rendering 106 in a user interface shown on display 120 of computer 110. In some implementations, the display device 120 can also be a display device of an alternate target computer 170. Once a 3D reconstruction is stored remotely at computer(s) 160, selected 3D reconstruction subsets 195 can be delivered to any suitable computer 110, 170, including computers that are not connected with the CT scanning device 130, and in some implementations, including computers that access the 3D construction through a Web browser program (i.e., the functionality at the local computer can be implemented by sending browser code to a traditional browser program).

The computer 110 can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a tablet computer or in virtual reality (VR) or augmented reality (AR) system. For example, the input/output devices 118, 120 can include a VR input glove 118a and a VR headset 120a. But regardless of the specific input/output devices employed, a user 102 can interact with the program(s) 116 to reconstruct and/or display a 3D reconstruction of a physical object.

The system 100 can stream X-Ray CT data from remote computer system(s) 160 (e.g., a cloud computer) to a browser of the local (target) computer 110. In some implementations, 3D reconstruction subset 195 and/or radiograph subset can be generated at remote computer system(s) 160 using the program(s) 116. The system 100 can send the 3D reconstruction subset 195 and/or radiograph subset through a network (e.g., a CDN) to a target computer 110, 170. In some implementations, the 3D reconstruction subset 195 and/or radiograph subset can be tailored to the network 150 and/or graphics processing at a target computer.

In some implementations, the network 150 can include a content delivery network (CDN), e.g., operating over the Internet or over a dedicated internal network of a cloud service provider. The CDN can include a system of pipes and caching servers to move large amounts of data around the globe and serve it with low latency to global users. For example, the content delivery network can include multiple servers spread around the globe that can facilitate faster data transfer between computers around the globe, the local computer 110, the target computer(s) 110, 170, and the remote computer system(s) 160. In some implementations, the CDN can be used in downloading data, e.g., from the remote computer system(s) 160 to the target computer(s) 110, 170. In some implementations, the CDN can be used in uploading data, e.g., from the local computer 110 to the remote computer system(s) 160 and the CDN can help improve upload speed.

FIG. 2 is a flowchart showing an example of operations 200 to process X-Ray computed tomography data in two or more connected locations. Two-dimensional (2D) radiograph data is received 205, e.g., by the program(s) 116. In some implementations, the system 100 (e.g., the local computer 110 or the remote computer system(s) 160) can receive radiograph data that has been at least partially processed locally at a computer (e.g., the local computer 110) coupled with a computed tomography scanner. The radiograph data can be for a physical object that has been scanned by the computed tomography scanner (e.g., the CT scanning device 130).

In some implementations, radiographs can be processed (e.g., through postprocessing operations) on the edge at the local computer coupled with the X-ray CT scanner. Postprocessed radiographs can be more compressible because noise, background data, etc., have been removed. Examples of the postprocessings of the radiographs can include denoising, flux normalization, flat field correction (e.g., corrections for baseline values read from detector when no part is in the CT scanner), calibration, bounding box cropping and/or masking, analog to digital bit depth calibration, binning/downsampling, skew correction, and pincushion correction. After the postprocessing, the postprocessed radiographs can have a more consistent, less noisy background with crisper, calibrated image detail. Thus, the background of the postprocessed radiographs can be more compressible.

Three-dimensional (3D) reconstruction is generated 220, e.g., by the program(s) 116. In some implementations, the system 100 can generate a three-dimensional reconstruction of a physical object from the radiograph data. In some implementations, the system can perform the reconstruction on the edge at the local computer 110 coupled with the CT scanning device 130. The system can quickly generate the 3D reconstruction for display to a user (e.g., the user 102 of the local computer 110) and the user can make mission-critical go or no-go decisions based on the scan data and/or the reconstruction. As used herein, the phrase “scan data” can refer to a combination of 2D X-ray radiographs, 3D reconstructions, acquisition settings, metadata, reconstruction data, rendering data, or a combination thereof.

For example, the system can display the 3D reconstruction to a user and the user can determine whether an anomaly can be found in the 3D reconstruction. In some implementations, the system can train a machine learning model on CT scan data for anomaly detection and the system can automatically detect potential anomalies using a trained machine learning model.

The 3D reconstruction is broken 225 into chunks, e.g., by the program(s) 116. In some implementations, the system 100 can break the three-dimensional reconstruction of the physical object into chunks of data selected to match an expected access pattern for data in the three-dimensional reconstruction. For example, the 3D reconstruction can have a large size (e.g., 5 GB or more), and the system can break the reconstruction into chucks before uploading from a local computer 110 to the remote computer system(s) 160 through the network 150.

In some implementations, the chunks can be split along one axis (e.g. X, Y, or Z) of the 3D reconstruction. In some implementations, the chunks can be split on multiple axes. In some implementations, the chunks can be 3D cubes of the 3D reconstruction. In some implementations, the chunks can be any portions of the 3D reconstruction that best match the data access pattern of the local operations 180 or remote operations 190 that use the chunks at a future time point. Therefore, the system can perform lazy-loading and/or partial-loading of the reconstruction data when processing the reconstruction data, e.g., at the remote computer system(s) 160.

For example, each chunk can be one slice of the data, and the corresponding data access pattern can be viewing one slice at a time along X, Y, or Z axis, or viewing one slice at a time along X, Y, or Z axis of a sub-region (e.g., described a bounding box). As another example, each chunk can be a cube or an axis-aligned box of the data, and the corresponding data access pattern can be viewing a common subset of the data (e.g., center, corner, or other location of a feature of an object, determined either automatically or by a user input), viewing the full volume and zooming in to a common location (e.g., center), or viewing a subset of the data defined by a cylinder or other geometric primitive. As another example, each chuck can be a rotated or otherwise transformed version of the volume in chucks and the data access pattern can include viewing non-axis-aligned data, such as viewing a rotating slice plane (e.g., a plane rotated about an arbitrary axis), viewing a rotated bounding box, or viewing a non-planar surface.

The chunks are compressed 230, e.g., by the program(s) 116. In some implementations, the system 100 can compress the chunks of data to form compressed chunks. By compressing on a per-chunk basis, and not a per-reconstruction basis, the system can load only sections of the reconstruction at a time into the memory of the computer (e.g., the local computer 110 and/or the remote computer systems 160) that uses or analyzes the reconstruction. By compressing the chunks, the system can reduce the bandwidth and the time to transfer the reconstruction over a network.

In some implementations, the chunks can be compressed on the edge, e.g., at the local computer 110. In some implementations, the chunks can be compressed in the cloud, e.g., at the remote computer system(s) 160. For example, the system can store the reconstruction data in the cloud in these compressed chunks regardless of whether the reconstruction was done on the edge or in the cloud. Thus, the system can provide the reconstruction data using the compressed chunks in the same manner for many different types of target computers, irrespective of the individual processing and memory resources of those target computers.

In some implementations, operations 220, 225, 230 can be performed as local operations 180 at computer 110. In such implementations, the compressed chunks can be sent 235 from the computer 110 to the remote computer system(s) 160 through the network 150. This removes the network 150 from the critical path of generating the 3D reconstruction and/or making decisions as to the quality of the product. Removing the network 150 from this critical path can be important in applications where users do not want the success or failure of the quality checks on their production line to be dependent on the presence or availability of network bandwidth. These implementations can also ensure low latency and can make it possible to serve applications which require hard, deterministic latencies such as applications which are tied into Programmable Logic Controller (PLC) systems.

In some implementations, the operations 220, 225, 230 can be performed as remote operations 190 at the remote computer system(s) 160. In these implementations, the manufacturer hardware Bill of Materials (BOM) costs can be reduced because they require less computer(s) to be manufactured and delivered with the X-Ray CT scanner. In these implementations, the computer(s) 160 which are performing the algorithmic steps can have higher overall utilization because data from multiple scanners can be processed on a single set of computer(s) 160.

In some implementations, local versus remote processing operations can be determined 210, e.g., by the program(s) 116. The system 100 can determine, based on one or more factors (e.g., local processing resources, local memory resource, bandwidth of the network connection, how quickly the user needs the 3D reconstruction and/or scanner usage), whether each of the generating 220, the breaking 225 and the compressing 230 are done locally at the computer coupled with the computed tomography scanner or at the one or more remote computers.

For example, in the case of scanner usage, the system can determine how many scans a CT scanner device performs. If the number of scans is less than a threshold, the system can determine to generate the reconstruction on the edge at the local computer coupled with the CT scanner. In some implementations, additional hardware can be installed in the local computer to support edge reconstruction. In some implementations, the system can dynamically switch from cloud reconstruction to edge reconstruction after the additional hardware is installed.

As another example, the one or more factors can include scan requirements. When users change scan settings, the requirements for the reconstruction machine (e.g., RAM, Graphics Processing Units, i.e., GPUs) can exceed what the CT scanner can handle. In some implementations, the system can send the CT scan data (e.g., 2D radiographs) to the cloud at the remote computer systems which can have more powerful/larger workers/instances.

As another example, the one or more factors can include bandwidth. Performing the reconstruction in the cloud requires lower bandwidth because the system may only need to upload the compressed 2D radiographs. In some implementations, when there is not enough bandwidth to keep up with the scan rate and uploading the reconstructions, the system can generate the reconstructions in the cloud at the remote computer system(s).

In some implementations, the system 100 determines which processing operations are performed as local operations 180 at the local computer 110, and which processing operations are performed as remote operations 190 at the remote computer system(s) 160. In some implementations, local versus remote processing operations (e.g., the generation of the 3D reconstruction) is predetermined, and the system does not dynamically switch the local versus remote processing operations.

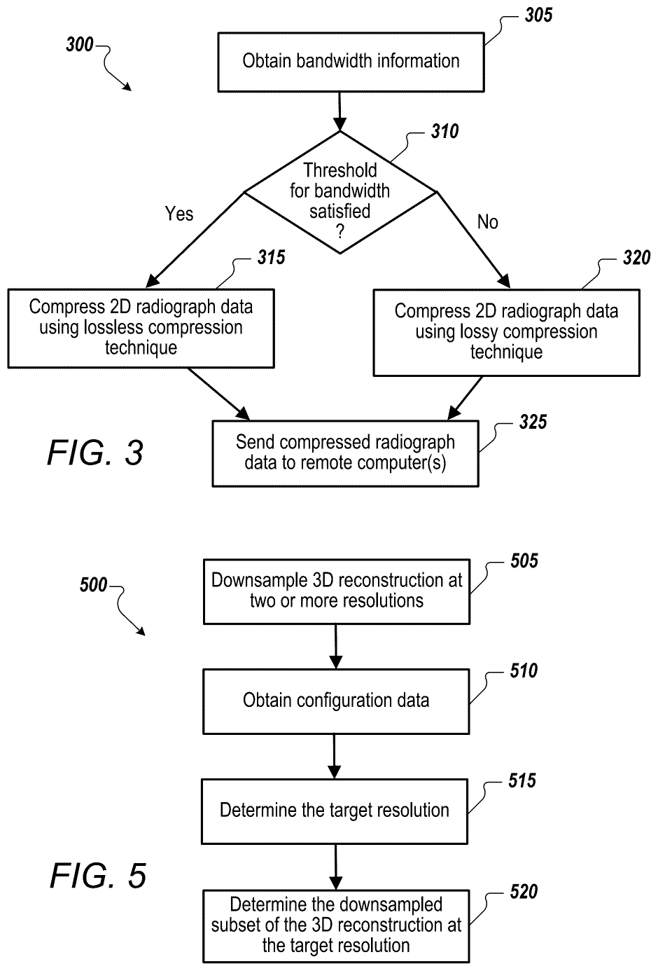

In some implementations, 2D radiograph data can be sent 215 to the remote computer system(s), e.g., by the program(s) 116. In some implementations, each of the generating 220, the breaking 225 and the compressing 230 can be done at the one or more computers (e.g., the remote computer systems 160), and the system can send the radiograph data from the computer coupled with the computed tomography scanner (e.g., the local computer 110) to the one or more remote computers through the computer network. In some implementations, the system can store radiographs in a compressed format. Details regarding compressing and storing the radiographs will be described in more detail in connection with FIG. 3.

For example, if the system 100 determines to generate 220 the 3D reconstruction remotely, the system 100 can send the 2D radiograph data to the remote computer system(s). For example, if the system 100 determines that there is a need to stream the 2D radiograph data to a target computer in the future, the system 100 can send the 2D radiograph data to the remote computer system(s) such that the remote computer system(s) can stream the 2D radiograph data to the target computer through the network 150.

In some implementations, the compressed chunks can be sent 235 to remote computer(s), e.g., by the program(s) 116. In some implementations, each of the generating 220, the breaking 225 and the compressing 230 can be done locally at the computer coupled with the computed tomography scanner, and the system can send the compressed chunks from the computer coupled with the computed tomography scanner to the one or more remote computers through the computer network.

The compressed chunks can be stored 240 on the remote computer(s), e.g., by the program(s) 116. In some implementations, the system can store the compressed chunks on one or more computers communicatively coupled with a computer network with which the computer coupled with the computed tomography scanner is communicatively coupled.

A compressed and downsampled subset of the 3D reconstruction is produced 245, e.g., by the program(s) 116. In some implementations, the system can produce, on the one or more computers, a compressed and downsampled subset of the three-dimensional reconstruction of the physical object from a proper subset of the compressed chunks in response to a request to access the three-dimensional reconstruction in a specified view. The compressed chunks can be selected for the proper subset based on the specified view. The compressed and downsampled subset of the 3D reconstruction can be called “dataview output”. In some implementations, the system can store the compressed chunks on a first subset of the one or more remote computers, and the system can produce the compressed and downsampled subset of the 3D reconstruction on a different second subset of the one or more remote computers. For example, in some cloud servers, there can be separate computers for data storage and data processing.

In some implementations, the system can use the region and level of detail requested for an analysis to determine which chunks contain the required data. In some implementations, the system can load the needed chunks, and can perform a resampling operation to prepare the data for analysis. In some implementations, resampling can involve spatial resampling such as 3D affine transform, cropping, and/or slicing. In some implementations, resampling can involve remapping the floating point value at each voxel to a different range, for example, to the range 0-255 or to binary data via a threshold.

In some implementations, the system can generate dataview outputs that are compatible with deployed computer graphics processors. In some implementations, no dimension of the compressed and downsampled subset of the three-dimensional reconstruction of the physical object is greater than 2048 pixels or voxels. In some implementations, the system can match texture formats or compressed texture formats. For example, if the graphics library at the target computer can handle u16 textures, the system can generate dataview outputs with u16 textures.

By providing the dataview outputs in a format that is compatible with (i.e., tailored to) the graphics card of the target computer, the system can avoid having to further process the dataview outputs on the target computer to make them compatible. For example, some but not all graphics cards support r16Unorm textures, which can allow a higher level of fidelity in the viewer for target computers with higher end graphics cards. And some, but not all graphics cards support S3TC compressed textures, which mean that the data can be downloaded, loaded into graphics memory, and displayed, all without ever expanding to its full uncompressed size. This can allow for increased resolution for customers with higher end graphics cards. If the system does not match texture formats, the system may have to cater to the lowest common denominator of the graphics card feature set.

The compressed and downsampled subset of the 3D reconstruction is sent 250 to a target computer, e.g., by the program(s) 116. In some implementations, the system can send the compressed and downsampled subset of the three-dimensional reconstruction of the physical object over the computer network to a target computer. The target computer can be the computer coupled with the computed tomography scanner or a different computer communicatively coupled with the computer network.

For example, radiographs and reconstructions can be stored in native, full resolution in the cloud. When a user requests a particular view into the radiographs or reconstruction (referred to as a “dataview”), the system can process the request for the view (e.g., 2D bounding box on radiograph, or 3D region of interest on reconstruction) and can downsample the full-resolution/native data to a size that can be transferred over the network (e.g., the Internet) efficiently and that the user's browser can handle.

In some implementations, after sending the compressed and downsampled subset to the target computer, the system can send more data. This can be based on an explicit request from a user (e.g., a request to view a region of the data in more detail), or can be determined automatically based on actions the user takes (e.g., rotating or zooming the view).

In some implementations, the system can process the chunks of data to generate an analysis result of the 3D reconstruction. For example, the analysis result can include a decision as to the quality of the physical object (e.g., a part), a process which runs on the 3D reconstruction to show a useful analysis to the user, mesh extractions, porosity analysis, sub-volumes, 2D dimensions, 3D dimensions, segmented bodies, and other derived data and analyses.

FIG. 3 is a flowchart showing an example of a process 300 to compress and send radiograph data. The system can compress the radiograph data to form compressed radiograph data locally at the computer coupled with the computed tomography scanner. For example, the process in FIG. 3 can be performed by X-Ray CT program(s) 116 at a local computer 110 coupled with a CT scanning device 130. The program(s) 116 can compress the radiographs on the edge before uploading to the cloud. Bandwidth information is obtained 305, e.g., by the program(s) 116. In some implementations, the system can obtain bandwidth information for a network connection between the computer network and the computer coupled with the computed tomography scanner.

The program(s) 116 determines 310 whether a threshold for bandwidth is satisfied. In some implementations, the system can determine that the bandwidth information satisfies a threshold. In response to determining that the threshold for bandwidth is satisfied, 2D radiograph data can be compressed 315 using lossless compression technique, e.g., by the program(s) 116. In response to determining that the threshold for bandwidth is not satisfied, 2D radiograph data can be compressed 320 using lossy compression technique, e.g., by the program(s) 116.

In some implementations, lossless compression technique is the preferred technique for compression, and the system can fall back to a lossy compression technique when determining that the threshold for bandwidth is not satisfied.

In some implementations, compression techniques for radiographs can include compressing on a per-image basis. For example, the system can compress one image at a time and each compressed image can be individually decompressible. Examples of lossy or lossless techniques for single image compression include Blosclz, Lz4, Lz4hc, Zlib, Zstd, PNG, JPEG, HEIF, Oodle compressors, bit depth decimation (e.g., 16 to 8 bit), etc.

In some implementations, compression techniques for radiographs can include compressing on a multi-image basis. The system can use video compression techniques on multiple radiographs to compress groups of multiple radiographs. Examples of lossy or lossless video compression techniques include H.264, H.265, HEVC, HEVC+Rext (e.g., for bit depths up to 16 bits), Libx265, and medical CT compression techniques. In some implementations, the system can use JPEG algorithm extended to 3D (e.g., 3D DCT+Quantization+entropy coding) to compress the multiple radiographs on a multi-image basis.

Compressed radiograph data is sent 325 to remote computer(s), e.g., by the program(s) 116. In some implementations, the system can send the compressed radiograph data from the computer coupled with the computed tomography scanner to the one or more computers through the computer network.

In some implementations, the process and techniques to compress and send radiograph data described in FIG. 3 can be applied to compressing and sending the chucks of the 3D reconstruction. In some implementations, the system can adaptively select lossless or lossy compression techniques to compress the chunks of the 3D reconstruction. For example, the system can select lossy or lossless compression based on available bandwidth.

In some implementations, the system can use lossy compression for the 3D reconstruction because if the system uses lossless compression for radiographs, the system can recover the original reconstruction if needed. In some implementations, the system can use lossy compression for both radiographs and 3D reconstruction if the bandwidth is limited and the lost data does not impact the application, e.g., the display and the analysis of the reconstruction and/or radiographs.

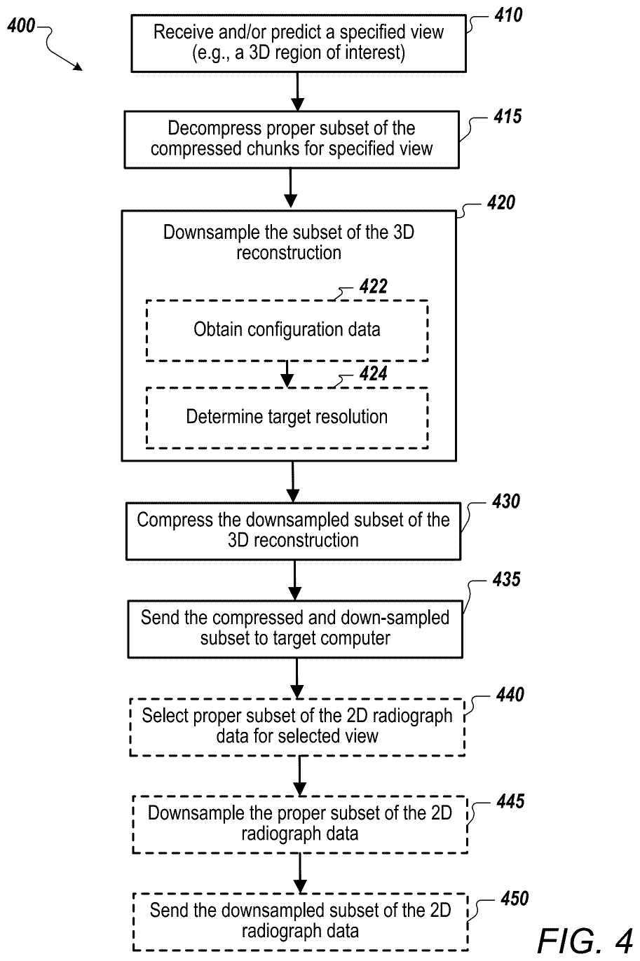

FIG. 4 is a flowchart showing an example of a process 400 to stream X-Ray computed tomography data to a target computer. A specified view is received and/or predicted 410, e.g., by the program(s) 116. In some implementations, the system can receive a specified view. In some implementations, a specified view can include a 3D region of interest (ROI) in the 3D reconstruction.

For example, the system can provide a variety of ways to request a resampled version of X-Ray computed tomography data. The system can provide a user interface (UI) for the user to specify a bounding box to crop the data (axis aligned or rotated), to specify a transformation matrix, to specify an output shape (e.g. to downsample to a certain number of voxels), to specify a maximum dimension size (e.g., would downsample if needed), to slice (e.g., selecting every X voxels along each axis, or selecting a specific plane), to map a range of floating point values to uint8 (0-255), etc. Each of these options allows the system to deliver the minimum amount of data that meets a particular request. In some implementations, the options that result in downsampling or mapping floating point values to uint8 can be considered a form of lossy compression. In some implementations, chunking (e.g., the operation 225 in FIG. 2) can be done before any requests based on expected usage patterns and not as a result of a specific request for an ROI.

In some implementations, the system can predict a next view to be specified based on a user's one or more interactions with prior scan data. For example, the system can predict a specified view based off of what a user may need from previous scans. For example, a user may often request ROI X, and the system can pre-generate dataview output at the ROI X. The system can accomplish this analytically/algorithmically. In some implementations, the system can explicitly ask the user to generate a “recipe” where the user often makes ROI X after finishing a reconstruction.

For example, the system can determine a 3D ROI that is specified explicitly by a user, e.g., by manually dragging a bounding box or range mapper handles to select the data they want to see. As another example, the system can determine a 3D ROI that is specified implicitly by a user, e.g., by zooming, panning, or rotating the viewport to only show the data they want to see. As another example, the system can determine a 3D ROI automatically, and an algorithm can decide what region it thinks is most likely relevant to the user (but the user can edit it if needed).

In some implementations, a user can indicate an ROI based on one or more of the following: any 3D geometric primitive, a combination of geometric primitives, a line or a curve through the data, an iso-surface defined by a threshold, dragging or drawing a 2D region of the display of the data that is projected into a 3D space, “painting” an arbitrary selection of voxels, uploading a computer aided design (CAD) file in any format to determine what part(s) of the data that user might care about, and any segmentation of the data (e.g., air versus object, different materials) done either by manually specifying threshold(s) or automatically. In some implementations, the system can determine a 3D ROI of a volume based on a previously defined ROI in another volume from a prior CT scan.

A proper subset of the compressed chunks for the specified view is decompressed 415, e.g., by the program(s) 116. In some implementations, the system can decompress the proper subset of the compressed chunks to form a subset of the three-dimensional reconstruction of the physical object.

The subset of the 3D reconstruction is downsampled 420, e.g., by the program(s) 116. In some implementations, the system can downsample the subset of the three-dimensional reconstruction of the physical object to form a downsampled subset of the three-dimensional reconstruction of the physical object at a target resolution. The target resolution can be a lower resolution than a resolution of the three-dimensional reconstruction of the physical object.

In some implementations, the system can pre-generate the downsampled subset of the 3D reconstruction. For example, MipMaps or image pyramids are pre-calculated sequences of images, each of which is a progressively lower resolution representation of the previous image. MipMapping is a technique for improving performance while minimizing loss of perceptual quality. Details of pre-generating dataview outputs using MipMap are described in connection with FIG. 5.

In some implementations, the system can generate the downsampled subset of the 3D reconstruction on-the-fly. In some implementations, configuration data can be obtained 422, e.g., by the program(s) 116. In some implementations, the system can obtain configuration data of at least one of the computer network, the target computer, and user preference. In some implementations, a target resolution can be determined 424, e.g., by the program(s) 116. In some implementations, the system can determine the target resolution based on the configuration data. The system can downsample the subset of the three-dimensional reconstruction of the physical object to form the downsampled subset of the three-dimensional reconstruction of the physical object at the target resolution.

In some implementations, the computer network can be the Internet, and a size of the compressed and downsampled subset of the three-dimensional reconstruction of the physical object can be within a range set to facilitate streaming the three-dimensional reconstruction of the physical object through the Internet via a content delivery network.

For example, the system can receive a request from a user interface in the browser. The system can include a cloud worker (e.g., a computer program that performs computer operations) that can handle the request. The system can stream the necessary radiographs/reconstruction chunks into the cloud worker handling the job. For example, the system can decompress a chunk if the chunk is compressed. The cloud worker can process the raw/native data and can downsample the data to a size which the system can stream over the internet and the browser/GPU can handle. For example, the size of the downsampled, uncompressed data packet of the three-dimensional reconstruction can be within 1 MB to 1 GB range, e.g., 100 MB. The size of the compressed and downsampled data packet can be data dependent, e.g., dependent on how much noise is in the data. For example, the compression ratio from an uncompressed and downsampled data packet to a compressed and downsampled data packet can be 3-4, 6-8, or 11-12. Thus, a data packet of 100 MB can be compressed to less than 10 MB in some cases.

The downsampled subset of the 3D reconstruction is compressed 430, e.g., by the program(s) 116. In some implementations, the system can compress the downsampled subset of the three-dimensional reconstruction of the physical object to form the compressed and downsampled subset of the three-dimensional reconstruction of the physical object. The system can compress the downsampled subset of the 3D reconstruction (e.g., the downsampled “dataview output”) using lossy or lossless techniques. This can reduce the size of the downsampled “dataview output” as it travels over the network. Example techniques for downsampling include Blosclz, Lz4, Lz4hc, Zlib, Zstd, PNG, JPEG, bit depth decimation (e.g., 16 to 8 bit), etc.

The compressed and downsampled subset of the 3D reconstruction is sent 435 to the target computer, e.g., by the program(s) 116. In some implementations, the system can send the compressed and downsampled subset of the 3D reconstruction to a target computer through a content delivery network. The content delivery network can have low initial latency, low repeated latency for requests to the same data. The content delivery network can be valuable for both the on-the-fly generation scenario and the MipMap generation scenario. For example, under the MipMap generation scenario, the content delivery network can make the user experience truly interactive and low-latency as the user is viewing the displayed radiographs and/or reconstruction.

In some implementations, the dataviews techniques for streaming the 3D reconstruction (e.g., the decompressing 415, the downsampling 420, the compressing 430, the sending 435) can apply to the streaming of the 2D radiographs. In some implementations, a proper subset of the 2D radiograph data for selected view can be selected 440, e.g., by the program(s) 116. In some implementations, the system can receive a second request to access the radiograph data in a second specified view. The system can select a proper subset of the radiograph data based on the second specified view. In some implementations, the system can automatically determine a specified view for the 2D radiograph data based on the 3D reconstruction data.

In some implementations, the proper subset of the 2D radiograph data can be downsampled 445, e.g., by the program(s) 116. In some implementations, the system can downsample the proper subset of the radiograph data to form a downsampled subset of the radiograph data. In some implementations, the downsampled subset of the 2D radiograph data can be sent 450, e.g., by the program(s) 116. In some implementations, the system can send the downsampled subset of the radiograph data over the computer network to the target computer.

FIG. 5 is a flowchart showing an example of a process 500 to pre-generate dataview outputs using MipMap. 3D reconstruction is downsampled 505 at two or more resolutions, e.g., by the program(s) 116. In some implementations, the system can downsample the three-dimensional reconstruction of the physical object at a plurality of resolutions to form a downsampled three-dimensional reconstruction of the physical object at the plurality of resolutions.

Configuration data is obtained 510, e.g., by the program(s) 116. In some implementations, the system can obtain configuration data of at least one of the computer network, the target computer, and user preference.

The target resolution is determined 515, e.g., by the program(s) 116. In some implementations, the system can determine the target resolution based on the configuration data.

The downsampled subset of the 3D reconstruction is determined 520 at the target resolution, e.g., by the program(s) 116. In some implementations, the system can determine (e.g., select), from the downsampled three-dimensional reconstruction of the physical object at the plurality of resolutions, the downsampled subset of the three-dimensional reconstruction of the physical object at the target resolution.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims.

What is claimed is:

1. A method comprising:
receiving radiograph data that has been at least partially processed locally at a computer coupled with a computed tomography scanner, wherein the radiograph data is for a physical object that has been scanned by the computed tomography scanner;
generating a three-dimensional reconstruction of the physical object from the radiograph data;
breaking the three-dimensional reconstruction of the physical object into chunks of data selected to match an expected access pattern for data in the three-dimensional reconstruction;
compressing the chunks of data to form compressed chunks;
storing the compressed chunks on one or more computers communicatively coupled with a computer network with which the computer coupled with the computed tomography scanner is communicatively coupled;
producing, on the one or more computers, a compressed and downsampled subset of the three-dimensional reconstruction of the physical object from a proper subset of the compressed chunks in response to a request to access the three-dimensional reconstruction in a specified view, wherein the compressed chunks are selected for the proper subset based on the specified view; and
sending the compressed and downsampled subset of the three-dimensional reconstruction of the physical object over the computer network to a target computer, wherein the target computer is the computer coupled with the computed tomography scanner or a different computer communicatively coupled with the computer network.

2. The method of claim 1, wherein each of the generating, the breaking and the compressing are done locally at the computer coupled with the computed tomography scanner, and the method comprises:
sending the compressed chunks from the computer coupled with the computed tomography scanner to the one or more computers through the computer network.

3. The method of claim 1, wherein each of the generating, the breaking and the compressing are done at the one or more computers, and the method comprises:
sending the radiograph data from the computer coupled with the computed tomography scanner to the one or more computers through the computer network.

4. The method of claim 1, comprising:
compressing the radiograph data to form compressed radiograph data locally at the computer coupled with the computed tomography scanner; and
sending the compressed radiograph data from the computer coupled with the computed tomography scanner to the one or more computers through the computer network.

5. The method of claim 4, comprising:
obtaining bandwidth information for a network connection between the computer network and the computer coupled with the computed tomography scanner;
determining that the bandwidth information satisfies a threshold; and
in response to determining that the bandwidth information satisfies the threshold, compressing the radiograph data using a lossless compression technique.

6. The method of claim 4, comprising:
obtaining bandwidth information for a network connection between the computer network and the computer coupled with the computed tomography scanner;
determining that the bandwidth information does not satisfy a threshold; and
in response to determining that the bandwidth information does not satisfy the threshold, compressing the radiograph data using a lossy compression technique.

7. The method of claim 1, wherein producing the compressed and downsampled subset of the three-dimensional reconstruction of the physical object from the proper subset of the compressed chunks comprises:
decompressing the proper subset of the compressed chunks to form a subset of the three-dimensional reconstruction of the physical object;
downsampling the subset of the three-dimensional reconstruction of the physical object to form a downsampled subset of the three-dimensional reconstruction of the physical object at a target resolution, wherein the target resolution is a lower resolution than a resolution of the three-dimensional reconstruction of the physical object; and
compressing the downsampled subset of the three-dimensional reconstruction of the physical object to form the compressed and downsampled subset of the three-dimensional reconstruction of the physical object.

8. The method of claim 7, wherein downsampling the subset of the three-dimensional reconstruction of the physical object comprises:
obtaining configuration data of at least one of the computer network, the target computer, and user preference;
determining the target resolution based on the configuration data; and
downsampling the subset of the three-dimensional reconstruction of the physical object to form the downsampled subset of the three-dimensional reconstruction of the physical object at the target resolution.

9. The method of claim 7, wherein downsampling the subset of the three-dimensional reconstruction of the physical object comprises:
downsampling the three-dimensional reconstruction of the physical object at a plurality of resolutions to form downsampled three-dimensional reconstruction of the physical object at the plurality of resolutions;
obtaining configuration data of at least one of the computer network, the target computer, and user preference;
determining the target resolution based on the configuration data; and
determining, from the downsampled three-dimensional reconstruction of the physical object at the plurality of resolutions, the downsampled subset of the three-dimensional reconstruction of the physical object at the target resolution.

10. The method of claim 1, further comprising:
receiving a second request to access the radiograph data in a second specified view;
selecting a proper subset of the radiograph data based on the second specified view;
downsampling the proper subset of the radiograph data to form a downsampled subset of the radiograph data; and
sending the downsampled subset of the radiograph data over the computer network to the target computer.

11. The method of claim 1, wherein the specified view comprises a three-dimensional region of interest.

12. The method of claim 1, comprising:
determining, based on one or more factors, whether each of the generating, the breaking and the compressing are done locally at the computer coupled with the computed tomography scanner or at the one or more computers.

13. The method of claim 1, wherein the computer network is Internet, and a size of the compressed and downsampled subset of the three-dimensional reconstruction of the physical object is within a range set to facilitate streaming the three-dimensional reconstruction of the physical object through the Internet via a content delivery network.

14. The method of claim 1, wherein no dimension of the compressed and downsampled subset of the three-dimensional reconstruction of the physical object is greater than 2048 pixels or voxels.

15. The method of claim 1, further comprising:
predicting a next view to be specified based on a user's one or more interactions with prior scan data.

16. The method of claim 1, wherein compressing the chunks of data to form the compressed chunks comprises:
obtaining bandwidth information for one or more of (i) a network connection between the computer network and the computer coupled with the computed tomography scanner, and (ii) a network connection between the computer network and the target computer;
determining that the bandwidth information satisfies a threshold; and
in response to determining that the bandwidth information satisfies the threshold, compressing the chunks of data using a lossless compression technique.

17. The method of claim 1, wherein compressing the chunks of data to form the compressed chunks comprises:
obtaining bandwidth information for one or more of (i) a network connection between the computer network and the computer coupled with the computed tomography scanner, and (ii) a network connection between the computer network and the target computer;
determining that the bandwidth information does not satisfy a threshold; and
in response to determining that the bandwidth information does not satisfy the threshold, compressing the chunks of data using a lossy compression technique.

18. A system comprising:
a data processing apparatus including at least one hardware processor; and
a non-transitory computer-readable medium encoding instructions configured to cause the data processing apparatus to perform operations comprising:
receiving radiograph data that has been at least partially processed locally at a computer coupled with a computed tomography scanner, wherein the radiograph data is for a physical object that has been scanned by the computed tomography scanner;
generating a three-dimensional reconstruction of the physical object from the radiograph data;
breaking the three-dimensional reconstruction of the physical object into chunks of data selected to match an expected access pattern for data in the three-dimensional reconstruction;
compressing the chunks of data to form compressed chunks;
storing the compressed chunks on one or more computers communicatively coupled with a computer network with which the computer coupled with the computed tomography scanner is communicatively coupled;
producing, on the one or more computers, a compressed and downsampled subset of the three-dimensional reconstruction of the physical object from a proper subset of the compressed chunks in response to a request to access the three-dimensional reconstruction in a specified view, wherein the compressed chunks are selected for the proper subset based on the specified view; and
sending the compressed and downsampled subset of the three-dimensional reconstruction of the physical object over the computer network to a target computer, wherein the target computer is the computer coupled with the computed tomography scanner or a different computer communicatively coupled with the computer network.

19. The system of claim 18, wherein the operations comprise:
compressing the radiograph data to form compressed radiograph data locally at the computer coupled with the computed tomography scanner; and
sending the compressed radiograph data from the computer coupled with the computed tomography scanner to the one or more computers through the computer network.

20. A non-transitory computer-readable medium encoding instructions operable to cause data processing apparatus to perform operations comprising:
receiving radiograph data that has been at least partially processed locally at a computer coupled with a computed tomography scanner, wherein the radiograph data is for a physical object that has been scanned by the computed tomography scanner;
generating a three-dimensional reconstruction of the physical object from the radiograph data;
breaking the three-dimensional reconstruction of the physical object into chunks of data selected to match an expected access pattern for data in the three-dimensional reconstruction;
compressing the chunks of data to form compressed chunks;
storing the compressed chunks on one or more computers communicatively coupled with a computer network with which the computer coupled with the computed tomography scanner is communicatively coupled;
producing, on the one or more computers, a compressed and downsampled subset of the three-dimensional reconstruction of the physical object from a proper subset of the compressed chunks in response to a request to access the three-dimensional reconstruction in a specified view, wherein the compressed chunks are selected for the proper subset based on the specified view; and
sending the compressed and downsampled subset of the three-dimensional reconstruction of the physical object over the computer network to a target computer, wherein the target computer is the computer coupled with the computed tomography scanner or a different computer communicatively coupled with the computer network.

21. The non-transitory computer-readable medium of claim 20, wherein producing the compressed and downsampled subset of the three-dimensional reconstruction of the physical object from the proper subset of the compressed chunks comprises:
decompressing the proper subset of the compressed chunks to form a subset of the three-dimensional reconstruction of the physical object;
downsampling the subset of the three-dimensional reconstruction of the physical object to form a downsampled subset of the three-dimensional reconstruction of the physical object at a target resolution, wherein the target resolution is a lower resolution than a resolution of the three-dimensional reconstruction of the physical object; and
compressing the downsampled subset of the three-dimensional reconstruction of the physical object to form the compressed and downsampled subset of the three-dimensional reconstruction of the physical object.
